(19) United States
(12) Patent Application Publication
(10) Pub. No.: US 2025/0219770 A1
(43) Pub. Date: Jul. 3, 2025

(54) ENHANCEMENT SCHEME OF PSFCH TRANSMISSION FOR NR SIDELINK COMMUNICATION IN UNLICENSED SPECTRUM

(71) Applicant: Nokia Technologies Oy, Espoo (FI)

(72) Inventors: Yong LIU, Shanghai (CN); Laura Luque SANCHEZ, Nibe (DK); Jianguo LIU, Shanghai (CN); Timo Erkki LUNTTILA, Espoo (FI); Renato Barbosa ABREU, Aalborg (DK); Ling YU, Kauniainen (FI); Nuno Manuel KIILERICH PRATAS, Gistrup (DK)

(21) Appl. No.: 18/852,611

(22) PCT Filed: Apr. 2, 2022
(86) PCT No.: PCT/CN2022/085170

§ 371 Date: Sep. 30, 2024

(51) Int. Cl. H04L 1/1829; H04W 72/40

(52) U.S. Cl. CPC H04L 1/1861; H04L 1/1854; H04W 72/40

(57) ABSTRACT

Embodiments of the present disclosure relate to devices, methods, apparatuses and computer readable storage media of an enhancement scheme of PSFCH transmission for NR SL communication in unlicensed spectrum. The method includes receiving, from a second device, a plurality of physical sidelink channels on multiple time instances, wherein the plurality of physical sidelink channels include Physical Sidelink Shared Channels (PSSCHs) and/or Physical Sidelink Control Channels (PSCCHs); determining a plurality of Physical Sidelink Feedback Channels (PSFCHs) in a plurality of Physical Resource Blocks (PRBs) within a first slot, wherein the plurality of PSFCHs convey Hybrid Automatic Repeat Request (HARQ) feedbacks corresponding to the plurality of physical sidelink channels; and transmitting, to the second device, the HARQ feedbacks on the plurality of PSFCHs in the plurality of PRBs.

### FIELD

Embodiments of the present disclosure generally relate to the field of communication and in particular to devices, methods, apparatuses and computer readable storage media for an enhancement scheme of Physical Sidelink Feedback Channel (PSFCH) transmission for New Radio (NR) sidelink (SL) communication in unlicensed spectrum.

### BACKGROUND

In Release 16, Physical Sidelink Feedback Channel (PSFCH) for sidelink communication was specified to carry HARQ feedback over the sidelink from a User Equipment (UE) which is an intended recipient of a Physical Sidelink Shared Channel (PSSCH) transmission to the UE which performed the transmission.

Support for NR-based access to unlicensed spectrum was also introduced in Release 16. In unlicensed spectrum, some spectrum regulatory requirements have been specified for the design of UL physical channels. Therefore, a HARQ feedback mechanism meeting the spectrum regulatory requirements in unlicensed spectrum is worth studying.

### SUMMARY

In general, example embodiments of the present disclosure provide an enhancement scheme of PSFCH transmission for NR sidelink communication in unlicensed spectrum.

In a first aspect, there is provided a method. The method comprises receiving, from a second device, a plurality of physical sidelink channels on multiple time instances, wherein each of the plurality of physical sidelink channels comprise a Physical Sidelink Shared Channel (PSSCH) and/or a Physical Sidelink Control Channel (PSCCH); determining a plurality of Physical Sidelink Feedback Channels (PSFCHs) in a plurality of Physical Resource Blocks (PRBs) within a first slot, wherein the plurality of PSFCHs convey Hybrid Automatic Repeat Request (HARQ) feedbacks corresponding to the plurality of physical sidelink channels; and transmitting, to the second device, the HARQ feedbacks on the plurality of PSFCHs in the plurality of PRBs.

In a second aspect, there is provided a method. The method comprises transmitting, to a first device, a plurality of physical sidelink channels on multiple time instances, wherein each of the plurality of physical sidelink channels comprise a Physical Sidelink Shared Channel (PSSCH) and/or a Physical Sidelink Control Channel (PSCCH); and receiving, from the first device, Hybrid Automatic Repeat Request (HARQ) feedbacks on a plurality of Physical Sidelink Feedback Channels (PSFCHs) in a plurality of Physical Resource Blocks (PRBs) within a first slot, wherein the HARQ feedbacks on the plurality of PSFCHs correspond to the plurality of physical sidelink channels.

In a third aspect, there is provided a first device. The first device comprises at least one processor; and at least one memory including computer program codes; the at least one memory and the computer program codes are configured to, with the at least one processor, cause the first device at least to perform at least the method of the first aspect.

In a fourth aspect, there is provided a second device. The second device comprises at least one processor; and at least one memory including computer program codes; the at least one memory and the computer program codes are configured to, with the at least one processor, cause the second device at least to perform at least the method of the second aspect.

In a fifth aspect, there is provided an apparatus. The apparatus comprises means for receiving, from a second device, a plurality of physical sidelink channels on multiple time instances, wherein each of the plurality of physical sidelink channels comprise a Physical Sidelink Shared Channel (PSSCH) and/or a Physical Sidelink Control Channel (PSCCH); means for determining a plurality of Physical Sidelink Feedback Channels (PSFCHs) in a plurality of Physical Resource Blocks (PRBs) within a first slot, wherein the plurality of PSFCHs convey Hybrid Automatic Repeat Request (HARQ) feedbacks corresponding to the plurality of physical sidelink channels; and means for transmitting, to the second device, the HARQ feedbacks on the plurality of PSFCHs in the plurality of PRBs.

In a sixth aspect, there is provided an apparatus. The apparatus comprises means for transmitting, to a first device, a plurality of physical sidelink channels on multiple time instances, wherein each of the plurality of physical sidelink channels comprise a Physical Sidelink Shared Channel (PSSCH) and/or a Physical Sidelink Control Channel (PSCCH); and means for receiving, from the first device, Hybrid Automatic Repeat Request (HARQ) feedbacks on a plurality of Physical Sidelink Feedback Channels (PSFCHs) in a plurality of Physical Resource Blocks (PRBs) within a first slot, wherein the HARQ feedbacks on the plurality of PSFCHs correspond to the plurality of physical sidelink channels.

In a seventh aspect, there is provided a computer readable medium having a computer program stored thereon which, when executed by at least one processor of a device, causes the device to carry out the method according to the first aspect.

In an eighth aspect, there is provided a computer readable medium having a computer program stored thereon which, when executed by at least one processor of a device, causes the device to carry out the method according to the second aspect.

Other features and advantages of the embodiments of the present disclosure will also be apparent from the following description of specific embodiments when read in conjunction with the accompanying drawings, which illustrate, by way of example, the principles of embodiments of the disclosure.

### BRIEF DESCRIPTION OF THE DRAWINGS

Embodiments of the disclosure are presented in the sense of examples and their advantages are explained in greater detail below, with reference to the accompanying drawings, where

FIG. 1 illustrates an example environment in which example embodiments of the present disclosure can be implemented;

FIG. 2 shows a signaling chart illustrating a process of HARQ feedbacks for NR sidelink communication in unlicensed spectrum according to some example embodiments of the present disclosure;

FIG. 3 shows an example of an enhanced PSFCH transmission scheme for NR sidelink communication in unlicensed spectrum according to some example embodiments of the present disclosure;

FIG. 4 shows an example of an enhanced PSFCH transmission scheme with retransmissions of missed HARQ feedbacks according to some example embodiments of the present disclosure;

FIG. 5 shows an example of an enhanced PSFCH transmission scheme with a time threshold for HARQ feedbacks according to some example embodiments of the present disclosure;

FIG. 6 shows an example of an enhanced PSFCH transmission scheme with a NACK feedback according to some example embodiments of the present disclosure;

FIG. 7 shows an example of an enhanced PSFCH transmission scheme with joint encoding of HARQ feedbacks according to some example embodiments of the present disclosure;

FIG. 8 shows a flowchart of an example method of an enhanced PSFCH transmission scheme for NR sidelink communication in unlicensed spectrum according to some example embodiments of the present disclosure;

FIG. 9 shows a flowchart of an example method of an enhanced PSFCH transmission scheme for NR sidelink communication in unlicensed spectrum according to some example embodiments of the present disclosure;

FIG. 10 shows a simplified block diagram of a device that is suitable for implementing example embodiments of the present disclosure; and

FIG. 11 shows a block diagram of an example computer readable medium in accordance with some embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish functionalities of various elements. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory (ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as fifth generation (5G) systems, Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communication between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the future fifth generation (5G) new radio (NR) communication protocols, and/or any other protocols either currently known or to be developed in the future. Embodiments of the present disclosure may be applied in various communication systems. Given the rapid development in communication, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR Next Generation NodeB (gNB), a Remote Radio Unit (RRU), a radio header (RH), a remote radio head (RRH), a relay, a low power node such as a femto, a pico, and so forth, depending on the applied terminology and technology. A RAN split architecture comprises a gNB-CU (Centralized unit, hosting RRC, SDAP and PDCP) controlling a plurality of gNB-DUs (Distributed unit, hosting RLC, MAC and PHY). A relay node may correspond to DU part of the IAB node.

The term “terminal device” refers to any end device that may be capable of wireless communication. By way of example rather than limitation, a terminal device may also be referred to as a communication device, user equipment (UE), a subscriber station (SS), a portable subscriber station, a mobile station (MS), or an access terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to Mobile Termination (MT) part of the integrated access and backhaul (IAB) node (a.k.a. a relay node). In the following description, the terms “terminal device”, “communication device”, “terminal”, “user equipment” and “UE” may be used interchangeably.

Although functionalities described herein can be performed, in various example embodiments, in a fixed and/or a wireless network node, in other example embodiments, functionalities may be implemented in a user equipment apparatus (such as a cell phone or tablet computer or laptop computer or desktop computer or mobile IoT device or fixed IoT device). This user equipment apparatus can, for example, be furnished with corresponding capabilities as described in connection with the fixed and/or the wireless network node(s), as appropriate. The user equipment apparatus may be the user equipment and/or or a control device, such as a chipset or processor, configured to control the user equipment when installed therein. Examples of such functionalities include the bootstrapping server function and/or the home subscriber server, which may be implemented in the user equipment apparatus by providing the user equipment apparatus with software configured to cause the user equipment apparatus to perform from the point of view of these functions/nodes.

As part of the spectrum regulatory requirements, for the uplink channels of NR-unlicensed system, Occupied Channel Bandwidth (OCB) shall be between 80% and 100% of the declared Nominal Channel Bandwidth. Moreover, in order to improve spectrum efficiency, the OCB may also be applied to sidelink communications. According to some conventional technologies, in unlicensed spectrum, channel access relies on LBT (listen-before-talk) to ensure fair coexistence of different wireless communication systems. LBT uncertainty in unlicensed spectrum may substantially reduce efficiency of sidelink communication. In unlicensed spectrum, when a Rx device is unable to perform the PSFCH transmission due to LBT failure, then in most cases this will lead the Tx device to perform a retransmission of PSSCH. This is not desired as a PSSCH occupies multiple PRBs (typically more than 10 PRBs) and most OFDM symbols of a slot, while a PSFCH only occupies one PRB and 2 OFDM symbols of a slot. Thus, from a resource saving perspective ensuring the reliable transmission of PSFCH is critical. Moreover, a PSFCH transmission specified for licensed spectrum only occupies one PRB, which doesn't meet the OCB regulatory requirement in unlicensed spectrum.

Therefore, HARQ feedback mechanism should be enhanced to more efficiently support NR sidelink communication in unlicensed spectrum and to also meet the OCB regulatory requirement.

Example embodiments of the present disclosure provide an enhancement scheme of PSFCH transmission for NR sidelink communication in unlicensed spectrum. In this enhancement scheme, at a slot with mapped PSFCH resource for the HARQ feedback corresponding to the latest PSSCH from a Transmit (Tx) device, a Receive (Rx) device transmits PSFCHs at interlaced PRBs including the mapped PSFCH resource, which convey the HARQ feedback corresponding to the latest PSSCH and the HARQ feedbacks corresponding to previous PSSCHs. The proposed scheme can ensure PSFCH transmissions meet OCB requirement and in the meantime increase reliability of HARQ feedbacks in unlicensed spectrum.

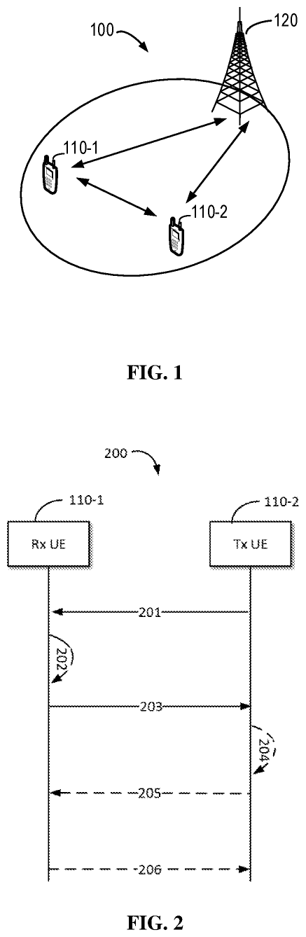

FIG. 1 shows an example communication network 100 in which embodiments of the present disclosure can be implemented. As shown in FIG. 1, the communication network 100 includes a terminal device 110-1 (hereinafter may also be referred to as a Rx UE 110-1 or a first device 110-1) and a further terminal device 110-2 (hereinafter may also be referred to as a Tx UE 110-2 or a second device 110-2). The communication network 100 may comprise a network device 120 (hereinafter may also be referred to as a gNB 120). The network device 120 may communicate with the terminal devices 110-1 and 110-2. The terminal devices 110-1 and 110-2 may communicate with each other. It is to be understood that the number of terminal devices and network devices are only for the purpose of illustration without suggesting any limitations. The communication network 100 may include any suitable number of terminal devices adapted for implementing embodiments of the present disclosure.

The communication network 100 can be implemented in a scenario of SL communication. In SL communication, the communication between terminal devices (for example, V2V, V2P, V2I communications) can be performed via sidelinks. For SL communication, information may be transmitted from a Tx terminal device to one or more Rx terminal devices in a broadcast, or groupcast, or unicast manner.

Depending on the communication technologies, the network 100 may be a Code Division Multiple Access (CDMA) network, a Time Division Multiple Address (TDMA) network, a Frequency Division Multiple Access (FDMA) network, an Orthogonal Frequency-Division Multiple Access (OFDMA) network, a Single Carrier-Frequency Division Multiple Access (SC-FDMA) network or any others. Communications discussed in the network 100 may conform to any suitable standards including, but not limited to, New Radio Access (NR), Long Term Evolution (LTE), LTE-Evolution, LTE-Advanced (LTE-A), Wideband Code Division Multiple Access (WCDMA), Code Division Multiple Access (CDMA), cdma2000, and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols. The techniques described herein may be used for the wireless networks and radio technologies mentioned above as well as other wireless networks and radio technologies. For clarity, certain aspects of the techniques are described below for NR, and NR terminology is used in much of the description below.

Principle and implementations of the present disclosure will be described in detail below with reference to FIG. 2, which show a schematic process of HARQ feedbacks for NR sidelink communication in unlicensed spectrum. For the purpose of discussion, the process 200 will be described with reference to FIG. 1. The process 200 may involve the Rx UE 110-1 and the Tx UE 110-2 as illustrated in FIG. 1.

The Tx UE 110-2 transmits 201 a plurality of physical sidelink channels on multiple time instances to the Rx UE 110-1. In some embodiments, the plurality of physical sidelink channels may comprise PSSCHs. Alternatively or in addition, the plurality of physical sidelink channels may comprise Physical Sidelink Control Channels (PSCCHs).

After receiving the physical sidelink channels from the Tx UE 110-2, the Rx UE 110-1 determines 202 PSFCHs in a plurality of Physical Resource Blocks (PRBs) within a slot. In some example embodiments, a PSFCH may use a PRB. Alternatively, a PSFCH transmission may use multiple PRBs. The PSFCHs convey HARQ feedbacks that correspond to the physical sidelink channels transmitted by the Tx UE 110-2.

In some embodiments, the PSFCHs convey HARQ feedbacks by a PSFCH format that indicates which PRB and which physical sidelink channel (e.g., PSSCH) are associated with each other. The PRB can be used to transmit a PSFCH conveying a HARQ feedback corresponding to the physical sidelink channel. Alternatively, the PSFCH format may indicate which PRB and which slot are associated with each other. The PRB can used to transmit a PSFCH conveying a HARQ feedback corresponding to the physical sidelink channel transmitted in the slot.

The PSFCH format can be known to both the Rx UE 110-1 and the Tx UE 110-2, which can be achieved by employing multiple mechanisms. For example, information on the PSFCH format can be included in a physical sidelink channel transmitted by the Tx UE 110-2 to inform the Rx UE 110-1. In this situation, the Rx UE 110-1 may determine the PSFCHs in a plurality of PRBs based on the PSFCH format. Alternatively, the PSFCH format may be configured or preconfigured at the Tx UE 110-2 and the Rx UE 110-1. For example, the PSFCH format may be included in a predetermined configuration. In this case, the Rx UE 110-1 may determine the PSFCHs in a plurality of PRBs based on the predetermined configuration. As a further example, part of the information on the PSFCH format can be included in a physical sidelink channel transmitted by the Tx UE 110-2 to inform the Rx UE 110-1. In this case, the PSFCH format may be derived based on the part of the information and a predetermined configuration, such as a configured or preconfigured rule or a rule specified in standard. As an example, the part of the information may include the number of previous physical sidelink channel transmissions that need to be fed back or the number of slots containing possible previous physical sidelink channel transmissions that need to be fed back.

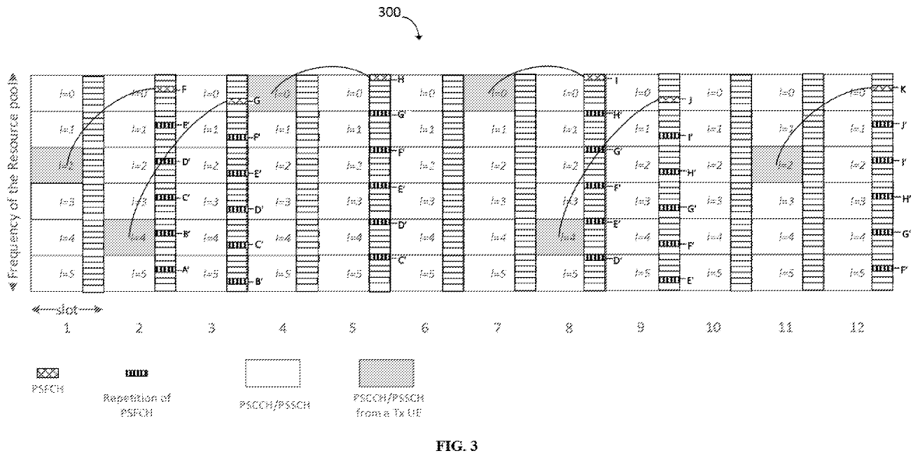

Then the Rx UE 110-1 transmits 203 the HARQ feedbacks on the plurality of PSFCHs in the plurality of PRBs to the Tx UE 110-2. The process of the transmission of the HARQ feedbacks on the plurality of PSFCHs in the plurality of PRBs will be described in detail below by referring to FIGS. 3 to 6.

In some example embodiments, the Tx UE 110-2 may transmit to the Rx UE 110-1 the physical sidelink channels in which PSSCH indexes are included. Each of the PSSCH indexes may correspond to one of the plurality of physical sidelink channels.

In some example embodiments, the Rx UE 110-1 may return the PSSCH indexes to the Tx UE 110-2 implicitly or explicitly with the HARQ feedbacks. If any of the PSSCH indexes is not comprised in the HARQ feedbacks, the Tx UE 110-2 may determine 204 that a HARQ feedback of a previous physical sidelink channel transmission is missed. Alternatively, the Tx UE 110-2 may determine 204 that a HARQ feedback of a previous physical sidelink channel transmission is missed by other means. In some example embodiments, if the Tx UE 110-2 determines that the missing of the HARQ feedback of a previous physical sidelink channel transmission, but there is no new PSSCH transmission from the Tx UE 110-2 (e.g. due to lack of SL data in the Tx buffer), then, the Tx UE 110-2 may perform 205 a HARQ retransmission of the previous physical sidelink channel to trigger the Rx UE 110-1 to provide a HARQ feedback of the previous physical sidelink channel transmission. In response to receiving the HARQ retransmission, the Rx UE 110-1 may retransmit 206 a HARQ feedback of the previous physical sidelink channel transmission to the Tx UE 110-2.

FIG. 3 shows an example of an enhanced PSFCH transmission scheme 300 for NR sidelink communication in unlicensed spectrum according to some example embodiments of the present disclosure. As mentioned above, as feedbacks to the physical sidelink channels transmitted by the Tx UE 110-2, the Rx UE 110-1 transmits the HARQ feedbacks on the plurality of PSFCHs in the plurality of PRBs to the Tx UE 110-2. FIG. 3 shows an example implementation of the HARQ feedback transmission. Only for the purpose of illustrations, embodiments of the present disclosure are described with reference to unicast scenario. It should be noted that embodiments of the present disclosure can also be applied to groupcast or broadcast scenario.

The Rx UE 110-1 transmits the HARQ feedbacks on the PSFCHs to the Tx UE 110-2. The frequency band (e.g., S PRBs: PRB 1, 2, . . . , S) of PSFCHs may be divided into M parts of same size. Each part may occupy N consecutive PRBs, which is named a PRB cluster. M=└S/N┘, where M may correspond to the number of PRBs in one SL sub-channel that is the SL resource granularity. The parameters S, M, and N are positive integers. In FIG. 3, S=36, N=6, M =6 are used just for simplicity. In some example embodiments, S=100, N=10, M=10 may be used. This disclosure does not make a limitation to them.

Assuming that the PSFCH resource for transmitting HARQ feedback (Hfⱼ) corresponding to the latest PSSCHⱼ is PRB_{w}(1<=w<=N) at slot t. The parameters j, w, and t are positive integers. By way of example, the mapping between PRB_{w} at slot t and PSSCHⱼ may follow the rule specified in any suitable specification. At slot t, the Rx UE 110-1 may transmit at PRB_{w} a PSFCH conveying the HARQ feedback (Hfⱼ) corresponding to the latest PSSCH (PSSCHⱼ) and may transmit at (M−1) PRBs (PRB_{w+N}, PRB_{w+2*N}, . . . , PRB_{w+(M-1)*N}) PSFCHs conveying the HARQ feedbacks (Hfⱼ₋₁, Hfⱼ₋₂, . . . , Hf_{j-M+1}) corresponding to (M−1) previous PSSCHs (PSSCHⱼ₋₁, PSSCHⱼ₋₂, . . . , PSSCH_{j-M+1}).

Referring to slot 12 as shown in FIG. 3, at slot 12, the Rx UE 110-1 may transmit at PRB₃ a PSFCH K conveying a HARQ feedback corresponding to the latest PSSCH, i.e., the PSSCH in subchannel 1=2 at slot 11. Besides the PSFCH K at PRB₃, the Rx UE 110-1 may transmit additional PSFCHs that convey HARQ feedbacks corresponding to previous PSSCHs at multiple PRBs which are distributed over the frequency band to meet OCB requirement. For example, the Rx UE 110-1 may transmit at PRB_{3+1*6} a PSFCH J′ that conveys the HARQ feedback corresponding to the PSSCH in subchannel 1=4 at slot 8. In addition, the Rx UE 110-1 may transmit at PRB_{3+2*6} a PSFCH I′ that conveys the HARQ feedback corresponding to the PSSCH in subchannel 1=0 at slot 7. In addition, the Rx UE 110-1 may transmit at PRB_{3+3*6} a PSFCH H′ that conveys the HARQ feedback corresponding to the PSSCH in subchannel 1=0 at slot 4. In addition, the Rx UE 110-1 may transmit at PRB_{3+4*6} a PSFCH G′ that conveys the HARQ feedback corresponding to the PSSCH in subchannel 1=4 at slot 2. In addition, the Rx UE 110-1 may transmit at PRB_{3+5*6} a PSFCH F′ that conveys the HARQ feedback corresponding to the PSSCH in subchannel 1=2 at slot 1.

As mentioned above, in some example embodiments, the Tx UE 110-2 may transmit to the Rx UE 110-1 the physical sidelink channels in which PSSCH indexes are included. For example, if the Tx UE 110-2 identifies the missing of HARQ feedbacks of multiple previous PSSCH transmissions, the Tx UE 110-2 may perform a HARQ retransmission of previous PSSCH transmission to trigger the Rx UE 110-1 to provide HARQ feedbacks of previous PSSCH transmissions using proposed enhanced PSFCH transmission scheme. This increases reliability of HARQ feedbacks by providing extra chance for a HARQ feedback if this HARQ feedback wasn't transmitted in previous slot(s) due to for example LBT failure(s). This also improves link level performance of HARQ feedbacks by providing time diversity to a HARQ feedback if this HARQ feedback was transmitted in previous slot(s).

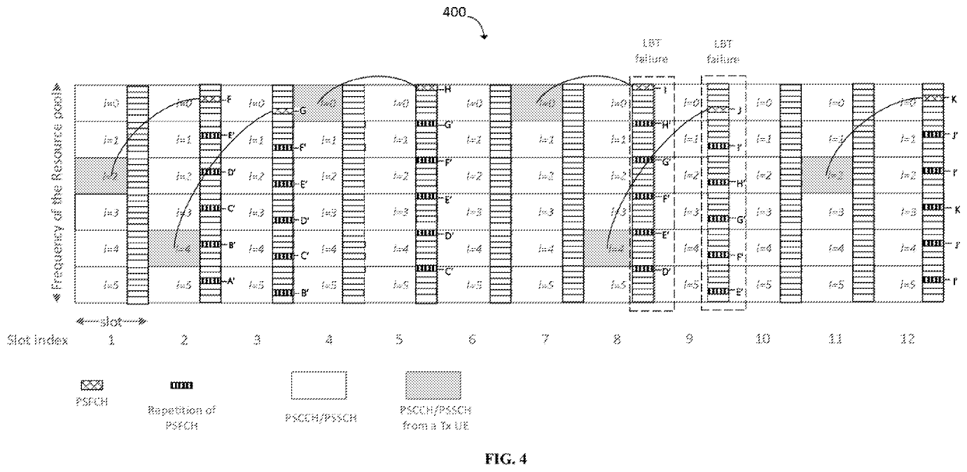

FIG. 4 shows an example of an enhanced PSFCH transmission scheme 400 with retransmissions of missed HARQ feedbacks according to some example embodiments of the present disclosure.

In some example embodiments, at a slot, the Rx UE 110-1 may transmit PSFCHs at multiple PRBs conveying the HARQ feedback corresponding to the latest PSSCH and conveying the HARQ feedbacks (corresponding to previous PSSCHs from the Tx UE 110-2) which weren't transmitted in previous slots due to for example LBT failures.

Referring to slot 12 as shown in FIG. 4, at slot 12, the Rx UE 110-1 may transmit at PRB₃ a PSFCH K that conveys the HARQ feedback corresponding to the latest PSSCH, i.e., the PSSCH in subchannel 1=2 at slot 11. Besides the PSFCH K at PRB₃, the Rx UE 110-1 may transmit additional PSFCHs at multiple PRBs which are distributed over the frequency band to meet OCB requirement. The additional PSFCHs may convey HARQ feedbacks corresponding to previous PSSCHs and corresponding to the latest PSSCH repeatedly. Moreover, the additional PSFCHs may convey HARQ feedbacks (corresponding to previous PSSCHs from the Tx UE 110-2) which weren't transmitted in previous slots due to for example LBT failures.

As an example illustrated in FIG. 4, at slot 12, besides the PSFCH K that conveys the HARQ feedback corresponding to the latest PSSCH at PRB₃, the Rx UE 110-1 may transmit the PSFCH K at PRB_{3+3*6} again. In addition, the Rx UE 110-1 may transmit the PSFCH J′ and the PSFCH I′ that weren't transmitted in previous slots due to for example LBT failures repeatedly at PRB_{3+1*6}, PRB₃₊₂₊₆, PRB_{3+4*6} and PRB_{3+5*6}.

In this way, reliability of HARQ feedbacks is increased by providing extra chance for a HARQ feedback if this HARQ feedback wasn't transmitted in previous slot(s) due to for example LBT failure(s).

More generally, the PSFCHs may convey HARQ feedbacks by a PSFCH format that indicates which PRB and which PSSCH are associated with each other. In this case, the PRB is used to transmit a PSFCH conveying a HARQ feedback corresponding to the associated PSSCH.

Alternatively, the PSFCHs may convey HARQ feedbacks by a PSFCH format that indicates which PRB and which slot are associated with each other. In this case, the PRB is used to transmit a PSFCH conveying a HARQ feedback corresponding to the PSSCH transmitted in the associated slot.

Alternatively, the PSFCHs may convey HARQ feedbacks by a PSFCH format that indicates which PRB and which slot are associated with each other. In this case, the Tx UE 110-2 may or may not transmit a PSSCH in the slot. If the Tx UE 110-2 transmits a PSSCH in the slot, the PRB is used to transmit a PSFCH conveying a HARQ feedback corresponding to the PSSCH transmitted in the associated slot. Otherwise, if the Tx UE 110-2 doesn't transmit a PSSCH in the slot, the PRB is used to transmit a PSFCH conveying a NACK.

Alternatively, the PSFCHs may convey HARQ feedbacks by a PSFCH format that indicates which PRB and which HARQ process number are associated with each other. In this case, the PRB is used to transmit a PSFCH conveying a HARQ feedback corresponding to the PSSCH with the associated HARQ process number.

Alternatively, the PSFCHs may convey HARQ feedbacks by a PSFCH format that indicates which PRB and which sequence number of higher layer (e.g. RLC) are associated with each other. In this case, the PRB is used to transmit a PSFCH conveying a HARQ feedback corresponding to the PSSCH with the associated sequence number.

In some example embodiments, the PSFCH format can be known to both the Tx UE 110-2 and the the Rx UE 110-1, which can be achieved by employing multiple mechanisms as described above.

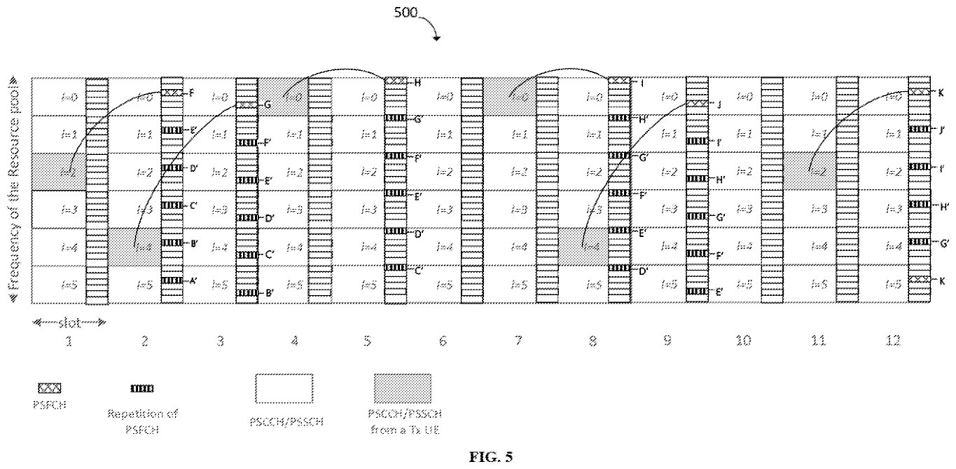

FIG. 5 shows an example of an enhanced PSFCH transmission scheme 500 with a time threshold for HARQ feedbacks according to some example embodiments of the present disclosure.

In some example embodiments, the Tx UE 110-2 may inform the Rx UE 110-1 a time threshold in the physical sidelink channels. Alternatively, the time threshold may be configured or preconfigured at the Rx UE 110-1. In some example embodiments, the time threshold may relate to the packet delay budget. At a slot, the Rx UE 110-1 may only transmit HARQ feedbacks corresponding to previous PSSCHs which were sent by the Tx UE 110-2 within the time threshold. If the number of HARQ feedbacks to be transmitted is less than M, a HARQ feedback (e.g. corresponding to the latest PSSCH) can be repeatedly transmitted in multiple PRBs to achieve frequency diversity.

As illustrated in FIG. 5, the HARQ feedback corresponding to the PSSCH that was sent quite long time ago (e.g., slot 1) may be not transmitted in slot 12. The HARQ feedback corresponding to the latest PSSCH can be repeatedly transmitted twice at PRB₃ and PRB_{3+5*6} in slot 12. That is, instead of transmitting the PSFCH F at PRB_{3+5*6} in slot 12, the Rx UE 110-1 may transmit the latest PSFCH K repeatedly at PRB₃ and PRB_{3+5*6} in slot 12.

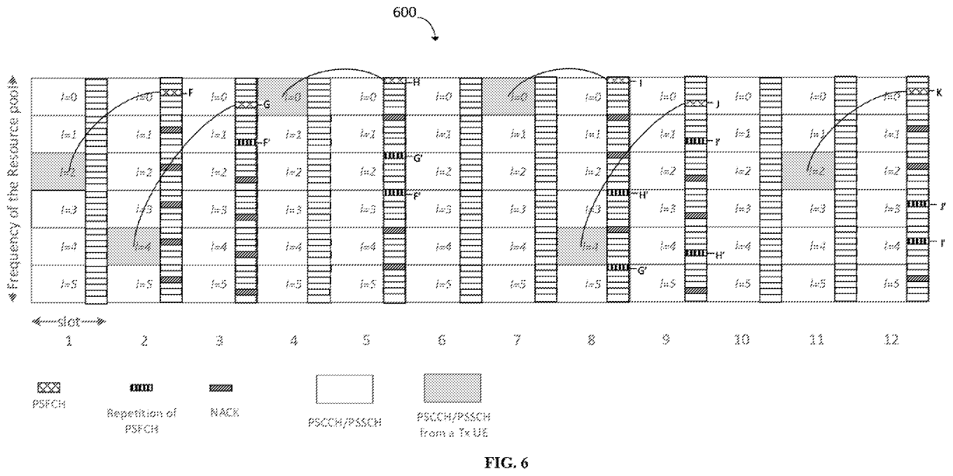

FIG. 6 shows an example of an enhanced PSFCH transmission scheme 600 with a NACK feedback according to some example embodiments of the present disclosure.

In some example embodiments, at a slot, the Rx UE 110-1 transmits the PSFCHs at multiple PRBs (e.g., M PRBs) conveying the HARQ feedback corresponding to the latest PSSCH sent in slot j and conveying the HARQ feedbacks corresponding to PSSCHs possibly sent in (M−1) previous slots (e.g. slot j−1, slot j−2, . . . , slot j−M+1). The Rx UE 110-1 transmits a NACK corresponding to a slot if no PSCCH towards itself was detected in the slot. By this way, signalling overhead can be reduced.

As an example illustrated in FIG. 6, at slot 12, PRB₃, PRB_{3+3*6} and PRB_{3+4*6} can be used for transmitting the PSFCHs K, J′ and I′, respectively. PRB_{3+1*6}, PRB_{3+2*6} and PRB_{3+5*6} may be used for transmitting NACKs since no PSCCH towards the Rx UE being decoded in slots 10, 9, and 6.

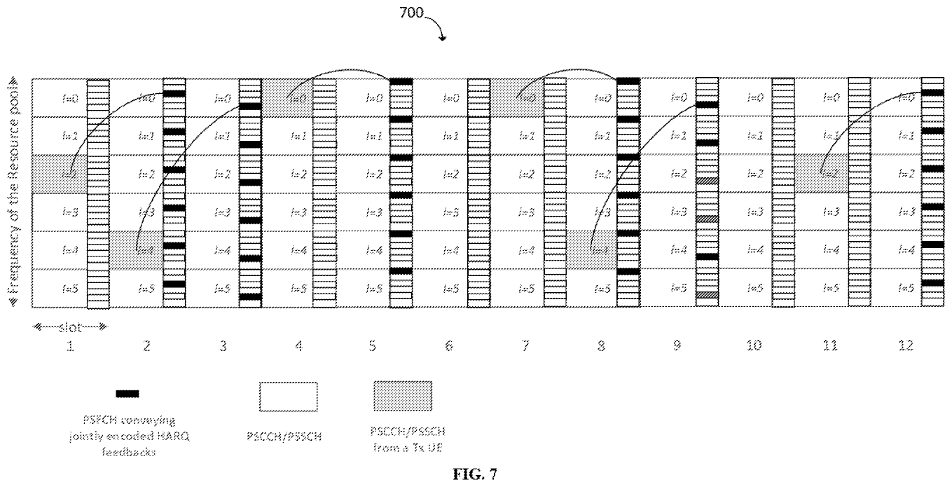

FIG. 7 shows an example of an enhanced PSFCH transmission scheme 700 with joint encoding of HARQ feedbacks according to some example embodiments of the present disclosure.

In some example embodiments, at a slot, the HARQ feedback corresponding to the latest PSSCH and other HARQ feedbacks corresponding to any previous PSSCHs from the Tx UE 110-2 are jointly encoded and transmitted at multiple PRBs of PSFCH resources.

As illustrated in FIG. 7, at slot 12, the Rx UE 110-1 determines the PSFCH resource (i.e., the PRBs at slot 12) for HARQ feedback corresponding to the latest PSSCH. As an example, the latest PSSCH for the HARQ feedback to be transmitted in slot 12 is in subchannel 1=2 at slot 11. In this case, the Rx UE 110-1 can determine that it may transmit a PSFCH for HARQ feedback at PRB₃ in slot 12. Besides the PSFCH at PRB₃, the Rx UE 110-1 may transmit at multiple PRBs which are distributed over the frequency band to meet OCB requirement.

The HARQ feedback set (e.g., the HARQ feedback corresponding to the latest PSSCH and other HARQ feedbacks corresponding to any previous PSSCHs) can be jointly encoded. Therefore, the Rx UE 110-1 can transmit PSFCHs for the jointly encoded HARQ feedback set at PRB₃, PRB_{3+1*6}, PRB_{3+2*6}, PRB_{3+3*6}, PRB_{3+4*6}, PRB_{3+5*6} in slot 12.

Alternatively, transmission of the jointly encoded HARQ feedback set in multiple PRBs can be considered as a single PSFCH.

In some example embodiments, the Tx UE 110-2 may inform the Rx UE 110-1 the HARQ feedback set in the physical sidelink channels. Alternatively, the HARQ feedback set may be configured or preconfigured at the Rx UE 110-1.

In some example embodiments, the Tx UE 110-2 may inform the Rx UE 110-1 in which slots previous PSSCHs were transmitted and the HARQ feedback set includes the HARQ feedbacks corresponding to the PSSCHs in the slots.

With the joint encoding scheme, reliability of HARQ feedbacks is increased by providing extra chance for a HARQ feedback if this HARQ feedback wasn't transmitted in previous slot(s) due to for example LBT failure(s). This also improves link level performance of HARQ feedbacks by providing time diversity to a HARQ feedback if this HARQ feedback was transmitted in previous slot(s).

For only illustration purpose, in FIG. 3 to FIG. 7, a PSSCH is illustrated as occupying consecutive PRBs. Alternatively, in unlicensed spectrum, a PSSCH may employ interlaced Frequency Division Multiplexing (FDM) structure adopted for new radio unlicensed (NR-U) uplink, i.e. a PSSCH may occupy one or more than one interlace of PRBs. But the mapping between PSSCHs and PSFCHs can be kept unchanged as illustrated in FIG. 3 to FIG. 7.

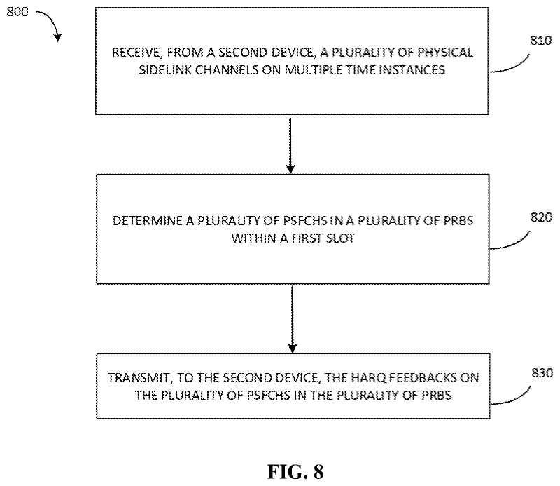

FIG. 8 shows a flowchart of an example method 800 of an enhanced PSFCH transmission scheme for NR sidelink communication in unlicensed spectrum according to some example embodiments of the present disclosure. The method 800 can be implemented at the first device 110-1 as shown in FIG. 1. For the purpose of discussion, the method 800 will be described with reference to FIG. 1 and FIG. 2.

At 810, the first device 110-1 receives, from a second device 110-2, a plurality of physical sidelink channels on multiple time instances. In some example embodiments, the plurality of physical sidelink channels may comprise PSSCHs. Alternatively or in addition, the plurality of physical sidelink channels may comprise PSCCHs.

At 820, the first device 110-1 determines a plurality of PSFCHs in a plurality of PRBs within a first slot. In some example embodiments, the plurality of PSFCHs may convey HARQ feedbacks corresponding to the plurality of physical sidelink channels.

In some example embodiments, the first device 110-1 may determine a PSFCH format based on at least one of information on the PSFCH format included in the plurality of physical sidelink channels. Alternatively or in addition, the first device 110-1 may determine the PSFCH format based on a predetermined configuration. In some example embodiments, the PSFCH format may indicate an association between the plurality of PRBs and the plurality of physical sidelink channels. Alternatively or in addition, the PSFCH format may indicate an association between the plurality of PRBs and slots in which the plurality of physical sidelink channels are transmitted by the second device.

At 830, the first device 110-1 transmits, to the second device 110-2, the HARQ feedbacks on the plurality of PSFCHs in the plurality of PRBs.

In some example embodiments, the first device 110-1 may transmit a first HARQ feedback on a first PSFCH of the plurality of PSFCHs in a first PRB of the plurality of PRBs. The first HARQ feedback may correspond to a latest physical sidelink channel of the plurality of physical sidelink channels. In some example embodiments, the first device 110-1 may transmit second HARQ feedbacks on a plurality of second PSFCHs of the plurality of PSFCHs in the plurality of PRBs. Each of the second HARQ feedbacks may correspond to a previous physical sidelink channel or the latest physical sidelink channel of the plurality of physical sidelink channels.

In some example embodiments, the first device 110-1 may transmit a first HARQ feedback on a first PSFCH of the PSFCHs in a first PRB of the plurality of PRBs. The first HARQ feedback may correspond to a physical sidelink channel of the plurality of physical sidelink channels received in a latest slot. In some example embodiments, the first device 110-1 may transmit second HARQ feedbacks on a plurality of second PSFCHs of the plurality of PSFCHs in the plurality of PRBs. Each of the second HARQ feedbacks corresponds to a physical sidelink channel of the plurality of physical sidelink channels received in a second slot prior to the latest slot. In some embodiments, if no physical sidelink channel is received in a second slot, the first device 110-1 may transmit a NACK on a PSFCH corresponding to the second slot.

In some example embodiments, each of the plurality of physical sidelink channels may comprise a PSSCH index. In addition, the HARQ feedbacks may implicitly or explicitly indicate the PSSCH index.

In some example embodiments, the first device 110-1 may further receive from the second device 110-2 a HARQ retransmission of one of the plurality of physical sidelink channels. In some example embodiments, the first device 110-1 may retransmit to the second device 110-2 a HARQ feedback corresponding to the one of the plurality of physical sidelink channels.

In some example embodiments, the first device 110-1 may evenly divide the plurality of PRBs into a plurality of PRB parts. In this case, if the number of the HARQ feedbacks to be transmitted is less than the number of the plurality of parts, the first device 110-1 may transmit a HARQ feedback of the HARQ feedbacks in at least one PRB part.

In some example embodiments, the first device 110-1 may determine a time threshold based on the plurality of physical sidelink channels or a predetermined configuration. If a subset of the plurality of physical sidelink channels is received within the time threshold before the first slot, the first device 110-1 may transmit a subset of the HARQ feedbacks corresponding to the subset of the plurality of physical sidelink channels on the plurality of PSFCHs.

In some example embodiments, the first device 110-1 may transmit the HARQ feedbacks on the plurality of PSFCHs in the plurality of PRBs based on the determined PSFCH format.

In some example embodiments, the HARQ feedbacks corresponding to the plurality of physical sidelink channels may be jointly encoded. The first device 110-1 may transmit the jointly encoded HARQ feedbacks in the plurality of PRBs.

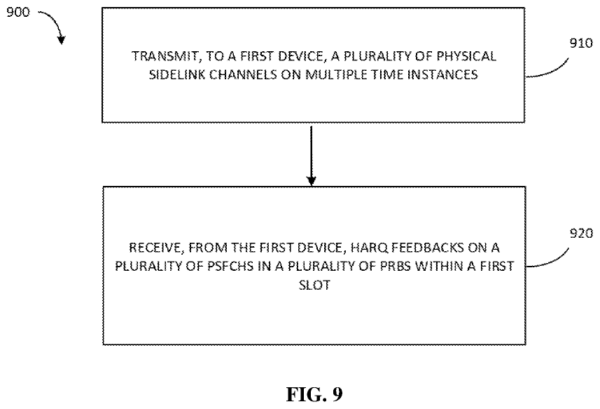

FIG. 9 shows a flowchart of an example method 900 of an enhanced PSFCH transmission scheme for NR sidelink communication in unlicensed spectrum according to some example embodiments of the present disclosure. The method 900 can be implemented at the second device 110-2 as shown in FIG. 1. For the purpose of discussion, the method 900 will be described with reference to FIG. 1 and FIG. 2.

At 910, the second device 110-2 transmits, to a first device 110-1, a plurality of physical sidelink channels on multiple time instances. In some example embodiments, the plurality of physical sidelink channels may comprise PSSCHs. Alternatively or in addition, the plurality of physical sidelink channels may comprise PSCCHs.

In some example embodiments, the second device 110-2 may transmit the plurality of physical sidelink channels including information on a PSFCH format. The PSFCH format may indicate an association between the plurality of PRBs and the plurality of physical sidelink channels. Alternatively or in addition, the PSFCH format may indicate an association between the plurality of PRBs and slots in which the plurality of physical sidelink channels are transmitted by the second device.

At 920, the second device 110-2 receives, from the first device 110-1, HARQ feedbacks on a plurality of PSFCHs in a plurality of PRBs within a first slot. The HARQ feedbacks on the plurality of PSFCHs correspond to the plurality of physical sidelink channels.

In some example embodiments, the second device 110-2 may receive a first HARQ feedback on a first PSFCH of the plurality of PSFCHs in a first PRB of the plurality of PRBs. The first HARQ feedback may correspond to a latest physical sidelink channel of the plurality of physical sidelink channels. In some example embodiments, the second device 110-2 may receive second HARQ feedbacks on a plurality of second PSFCHs of the plurality of PSFCHs in the plurality of PRBs. Each of the second HARQ feedbacks corresponds to a previous physical sidelink channel or the latest physical sidelink channel of the plurality of physical sidelink channels.

In some example embodiments, the second device 110-2 may receive a first HARQ feedback on a first PSFCH of the plurality of PSFCHs in a first PRB of the plurality of PRBs. The first HARQ feedback may correspond to a physical sidelink channel of the plurality of physical sidelink channels transmitted to the first device in a latest slot. In some example embodiments, the second device 110-2 may receive second HARQ feedbacks on a plurality of second PSFCHs of the plurality of PSFCHs in the plurality of PRBs other than the first PRB. Each of the second HARQ feedbacks corresponds to a physical sidelink channel of the plurality of physical sidelink channels transmitted to the first device in a second slot prior to the latest slot. In some example embodiments, the second device 110-2 may receive a NACK on a PSFCH corresponding to a second slot in which no PSCCH towards the first device is decodedat the first device.

In some example embodiments, each of the plurality of physical sidelink channels may include a PSSCH index.

In some example embodiments, the second device 110-2 may determine based on the PSSCH index indicated implicitly or explicitly in the HARQ feedbacks that a HARQ feedback corresponding to one of the plurality of physical sidelink channels is missed. In some example embodiments, the second device 110-2 may transmit a HARQ retransmission of the one of the plurality of physical sidelink channels.

In some example embodiments, the second device 110-2 may receive the HARQ feedbacks on the plurality of PSFCHs repeatedly transmitted at the plurality of PRBs.

In some example embodiments, the second device 110-2 may transmit a maximum time threshold in the plurality of physical sidelink channels to the first device. In some example embodiments, the second device 110-2 may receive, from the first device 110-1, a subset of the HARQ feedbacks on the plurality of PSFCHs correspond to a subset of the plurality of physical sidelink channels. The subset of the plurality of physical sidelink channels may be transmitted within the time threshold before the first slot.

In some example embodiments, the second device 110-2 may receive the HARQ feedbacks on the plurality of PSFCHs in the plurality of PRBs transmitted by the first device based on the PSFCH format.

In some example embodiments, the HARQ feedbacks corresponding to the plurality of physical sidelink channels may be jointly encoded. In some example embodiments, the second device 110-2 may receive the HARQ feedbacks in the plurality of PRBs by receiving the jointly encoded HARQ feedbacks in the plurality of PRBs.

In some example embodiments, a first apparatus for performing the method 800 (for example, the first device 110-1) may comprise respective means for performing the corresponding steps in the method 800. These means may be implemented in any suitable manners. For example, it can be implemented by circuitry or software modules.

The first apparatus comprises means for receiving, from a second apparatus, a plurality of physical sidelink channels on multiple time instances, wherein the plurality of physical sidelink channels comprise Physical Sidelink Shared Channels (PSSCHs) and/or Physical Sidelink Control Channels (PSCCHs); means for determining a plurality of Physical Sidelink Feedback Channels (PSFCHs) in a plurality of Physical Resource Blocks (PRBs) within a first slot, wherein the plurality of PSFCHs convey Hybrid Automatic Repeat Request (HARQ) feedbacks corresponding to the plurality of physical sidelink channels; and means for transmitting, to the second device, the HARQ feedbacks on the plurality of PSFCHs in the plurality of PRBs.

In some example embodiments, the first apparatus may comprise means for transmitting a first HARQ feedback on a first PSFCH of the plurality of PSFCHs in a first PRB of the plurality of PRBs, wherein the first HARQ feedback corresponds to a latest physical sidelink channel of the plurality of physical sidelink channels; and means for transmitting second HARQ feedbacks on a plurality of second PSFCHs of the plurality of PSFCHs in the plurality of PRBs, wherein each of the second HARQ feedbacks corresponds to a previous physical sidelink channel or the latest physical sidelink channel of the plurality of physical sidelink channels.

In some example embodiments, the first apparatus may comprise means for transmitting a first HARQ feedback on a first PSFCH of the PSFCHs in a first PRB of the plurality of PRBs, wherein the first HARQ feedback corresponds to a physical sidelink channel of the plurality of physical sidelink channels received in a latest slot; means for transmitting second HARQ feedbacks on a plurality of second PSFCHs of the plurality of PSFCHs in the plurality of PRBs, wherein each of the second HARQ feedbacks corresponds to a physical sidelink channel of the plurality of physical sidelink channels received in a second slot prior to the latest slot; and in accordance with a determination that no physical sidelink channel is received in a second slot, means for transmitting a NACK on a PSFCH corresponding to the second slot.

In some example embodiments, the first apparatus may comprise means for receiving from the second device a HARQ retransmission of one of the plurality of physical sidelink channels; and means for retransmitting to the second device a HARQ feedback corresponding to the one of the plurality of physical sidelink channels.

In some example embodiments, the first apparatus may comprise means for evenly dividing the plurality of PRBs into a plurality of PRB parts; and in accordance with a determination that the number of the HARQ feedbacks to be transmitted are less than the number of the plurality of parts, means for transmitting a HARQ feedback of the HARQ feedbacks in at least one PRB part.

In some example embodiments, the first apparatus may comprise means for determining a time threshold based on the plurality of physical sidelink channels or a predetermined configuration; and in accordance with a determination that a subset of the plurality of physical sidelink channels is received within the time threshold before the first slot, means for transmitting a subset of the HARQ feedbacks corresponding to the subset of the plurality of physical sidelink channels on the plurality of PSFCHs.

In some example embodiments, the first apparatus may comprise means for determining a PSFCH format based on at least one of information on the PSFCH format included in the plurality of physical sidelink channels or a predetermined configuration, wherein the PSFCH format may indicate one of an association between the plurality of PRBs and the plurality of physical sidelink channels, or an association between the plurality of PRBs and slots in which the plurality of physical sidelink channels are transmitted by the second device.

In some example embodiments, the first apparatus may comprise means for transmitting the HARQ feedbacks on the plurality of PSFCHs in the plurality of PRBs based on the determined PSFCH format.

In some example embodiments, the HARQ feedbacks corresponding to the plurality of physical sidelink channels may be jointly encoded, and the first apparatus may comprise means for transmitting the jointly encoded HARQ feedbacks in the plurality of PRBs.

In some example embodiments, a second apparatus for performing the method 900 (for example, the second device 110-2) may comprise respective means for performing the corresponding steps in the method 900. These means may be implemented in any suitable manners. For example, it can be implemented by circuitry or software modules.

The second apparatus comprises means for transmitting, to a first apparatus, a plurality of physical sidelink channels on multiple time instances, wherein the plurality of physical sidelink channels comprise Physical Sidelink Shared Channels (PSSCHs) and/or Physical Sidelink Control Channels (PSCCHs); and means for receiving, from the first device, Hybrid Automatic Repeat Request (HARQ) feedbacks on a plurality of Physical Sidelink Feedback Channels (PSFCHs) in a plurality of Physical Resource Blocks (PRBs) within a first slot, wherein the HARQ feedbacks on the plurality of PSFCHs correspond to the plurality of physical sidelink channels.

In some example embodiments, the second apparatus may comprise means for receiving a first HARQ feedback on a first PSFCH of the plurality of PSFCHs in a first PRB of the plurality of PRBs, wherein the first HARQ feedback corresponds to a latest physical sidelink channel of the plurality of physical sidelink channels; and means for receiving second HARQ feedbacks on a plurality of second PSFCHs of the plurality of PSFCHs in the plurality of PRBs, wherein each of the second HARQ feedbacks corresponds to a previous physical sidelink channel or the latest physical sidelink channel of the plurality of physical sidelink channels.

In some example embodiments, the second apparatus may comprise means for receiving a first HARQ feedback on a first PSFCH of the plurality of PSFCHs in a first PRB of the plurality of PRBs, wherein the first HARQ feedback corresponds to a physical sidelink channel of the plurality of physical sidelink channels transmitted to the first device in a latest slot; means for receiving second HARQ feedbacks on a plurality of second PSFCHs of the plurality of PSFCHs in the plurality of PRBs other than the first PRB, wherein each of the second HARQ feedbacks corresponds to a physical sidelink channel of the plurality of physical sidelink channels transmitted to the first device in a second slot prior to the latest slot; and means for receiving a NACK on a PSFCH corresponding to a second slot in which no PSCCH towards the first device is decoded at the first device.

In some example embodiments, each of the plurality of physical sidelink channels may include a PSSCH index, and the second apparatus may comprise means for determining based on the PSSCH index indicated implicitly or explicitly in the HARQ feedbacks that a HARQ feedback corresponding to one of the plurality of physical sidelink channels is missed; and means for transmitting a HARQ retransmission of the one of the plurality of physical sidelink channels.

In some example embodiments, the second apparatus may comprise means for receiving the HARQ feedbacks on the plurality of PSFCHs repeatedly transmitted at the plurality of PRBs.

In some example embodiments, the second apparatus may comprise means for transmitting a maximum time threshold in the plurality of physical sidelink channels to the first device; and means for receiving, from the first device, a subset of the HARQ feedbacks on the plurality of PSFCHs correspond to a subset of the plurality of physical sidelink channels, and wherein the subset of the plurality of physical sidelink channels is transmitted within the time threshold before the first slot.

In some example embodiments, the second apparatus may comprise means for transmitting the plurality of physical sidelink channels including information on a PSFCH format, wherein the PSFCH format may indicate one of an association between the plurality of PRBs and the plurality of physical sidelink channels, or an association between the plurality of PRBs and slots in which the plurality of physical sidelink channels are transmitted by the second device.

In some example embodiments, the second apparatus may comprise means for receiving the HARQ feedbacks on the plurality of PSFCHs in the plurality of PRBs transmitted by the first device based on the PSFCH format.

In some example embodiments, the HARQ feedbacks corresponding to the plurality of physical sidelink channels may be jointly encoded, and the second apparatus may comprise means for receiving the jointly encoded HARQ feedbacks in the plurality of PRBs.

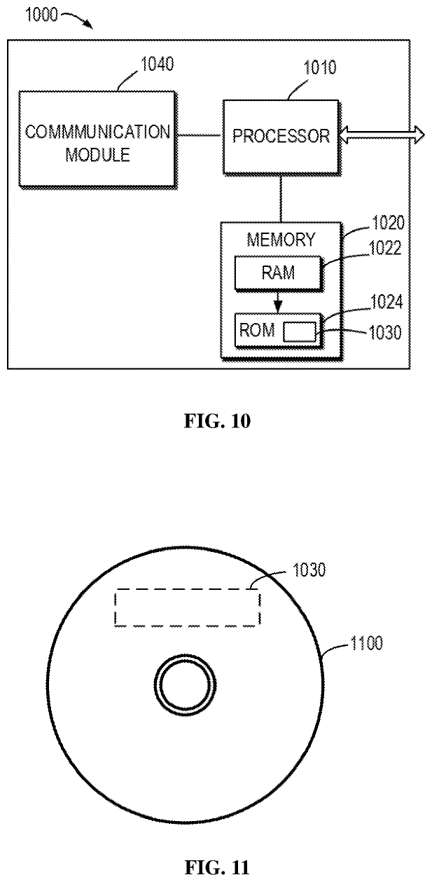

FIG. 10 is a simplified block diagram of a device 1000 that is suitable for implementing embodiments of the present disclosure. The device 1000 may be provided to implement the communication device, for example the UE 110-1 and the further UE 110-2 as shown in FIG. 1. As shown, the device 1000 includes one or more processors 1010, one or more memories 1040 coupled to the processor 1010, and one or more communication modules (TX/RX) 1040 coupled to the processor 1010.

The TX/RX 1040 is for bidirectional communications. The TX/RX 1040 has at least one antenna to facilitate communication. The communication interface may represent any interface that is necessary for communication with other network elements.

The processor 1010 may be of any type suitable to the local technical network and may include one or more of the following: general purpose computers, special purpose computers, microprocessors, digital signal processors (DSPs) and processors based on multicore processor architecture, as non-limiting examples. The device 800 may have multiple processors, such as an application specific integrated circuit chip that is slaved in time to a clock which synchronizes the main processor.

The memory 1020 may include one or more non-volatile memories and one or more volatile memories. Examples of the non-volatile memories include, but are not limited to, a Read Only Memory (ROM) 1024, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 1022 and other volatile memories that will not last in the power-down duration.

A computer program 1030 includes computer executable instructions that are executed by the associated processor 1010. The program 1030 may be stored in the ROM 1020. The processor 1010 may perform any suitable actions and processing by loading the program 1030 into the RAM 1020.

The embodiments of the present disclosure may be implemented by means of the program 1030 so that the device 1000 may perform any process of the disclosure as discussed with reference to FIGS. 2 to 9. The embodiments of the present disclosure may also be implemented by hardware or by a combination of software and hardware.

In some embodiments, the program 1030 may be tangibly contained in a computer readable medium which may be included in the device 1000 (such as in the memory 1020) or other storage devices that are accessible by the device 1000. The device 1000 may load the program 1030 from the computer readable medium to the RAM 1022 for execution. The computer readable medium may include any types of tangible non-volatile storage, such as ROM, EPROM, a flash memory, a hard disk, CD, DVD, and the like. FIG. 11 shows an example of the computer readable medium 1100 in form of CD or DVD. The computer readable medium has the program 1030 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, device, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the methods 800-900 as described above with reference to FIGS. 8 to 9. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing device, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, device or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, device, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementting the claims.

1.-23. (canceled)

24. A method comprising:
receiving, from a second device, a plurality of physical sidelink channels on multiple time instances, wherein the plurality of physical sidelink channels comprise Physical Sidelink Shared Channels (PSSCHs) and/or Physical Sidelink Control Channels (PSCCHs); determining a plurality of Physical Sidelink Feedback Channels (PSFCHs) in a plurality of Physical Resource Blocks (PRBs) within a first slot, wherein the plurality of PSFCHs convey Hybrid Automatic Repeat Request (HARQ) feedbacks corresponding to the plurality of physical sidelink channels; and
transmitting, to the second device, the HARQ feedbacks on the plurality of PSFCHs in the plurality of PRBs.

25. The method as claimed in claim 24, wherein transmitting the HARQ feedbacks on the plurality of PSFCHs comprises:
transmitting a first HARQ feedback on a first PSFCH of the plurality of PSFCHs in a first PRB of the plurality of PRBs, wherein the first HARQ feedback corresponds to a latest physical sidelink channel of the plurality of physical sidelink channels; and
transmitting second HARQ feedbacks on a plurality of second PSFCHs of the plurality of PSFCHs in the plurality of PRBs, wherein each of the second HARQ feedbacks corresponds to the latest physical sidelink channel or a previous physical sidelink channel of the plurality of physical sidelink channels.

26. The method as claimed in claim 24, wherein transmitting the HARQ feedbacks on the plurality of PSFCHs comprises:
transmitting a first HARQ feedback on a first PSFCH of the plurality of PSFCHs in a first PRB of the plurality of PRBs, wherein the first HARQ feedback corresponds to a physical sidelink channel of the plurality of physical sidelink channels received in a latest slot;
transmitting second HARQ feedbacks on a plurality of second PSFCHs of the plurality of PSFCHs in the plurality of PRBs, wherein each of the second HARQ feedbacks corresponds to a physical sidelink channel of the plurality of physical sidelink channels received in a second slot prior to the latest slot; and
in accordance with a determination that no physical sidelink channel is received in a second slot, transmitting a NACK on a PSFCH corresponding to the second slot.

27. The method as claimed in claim 24, wherein each of the plurality of physical sidelink channels comprises:
a PSSCH index, and the HARQ feedbacks indicate implicitly or explicitly the PSSCH index.

28. The method as claimed in claim 27, wherein the method further comprises:
receiving from the second device a HARQ retransmission of one of the plurality of physical sidelink channels; and
retransmitting to the second device a HARQ feedback corresponding to the one of the plurality of physical sidelink channels.

29. The method as claimed in claim 24, wherein transmitting the HARQ feedbacks on the plurality of PSFCHs comprises:
evenly dividing the plurality of PRBs into a plurality of PRB parts; and
in accordance with a determination that the number of the HARQ feedbacks to be transmitted are less than the number of the plurality of parts, transmitting a HARQ feedback of the HARQ feedbacks in at least one PRB part.

30. The method as claimed in claim 24, wherein transmitting the HARQ feedbacks on the plurality of PSFCHs comprises:
determining a time threshold based on the plurality of physical sidelink channels or a predetermined configuration; and
in accordance with a determination that a subset of the plurality of physical sidelink channels is received within the time threshold before the first slot, transmitting a subset of the HARQ feedbacks corresponding to the subset of the plurality of physical sidelink channels on the plurality of PSFCHs.

31. The method as claimed in claim 24, wherein determining the plurality of PSFCHs in the plurality of PRBs within the first slot comprises:
determining a PSFCH format based on at least one of information on the PSFCH format included in the plurality of physical sidelink channels or a predetermined configuration, wherein the PSFCH format indicates one of:
an association between the plurality of PRBs and the plurality of physical sidelink channels, or
an association between the plurality of PRBs and slots in which the plurality of physical sidelink channels are transmitted by the second device.

32. The method as claimed in claim 31, wherein transmitting the HARQ feedbacks on the plurality of PSFCHs comprises:
transmitting the HARQ feedbacks on the plurality of PSFCHs in the plurality of PRBs based on the determined PSFCH format.

33. A method, comprising:
transmitting, to a first device, a plurality of physical sidelink channels on multiple time instances, wherein the plurality of physical sidelink channels comprise Physical Sidelink Shared Channels (PSSCHs) and/or Physical Sidelink Control Channels (PSCCHs); and
receiving, from the first device, Hybrid Automatic Repeat Request (HARQ) feedbacks on a plurality of Physical Sidelink Feedback Channels (PSFCHs) in a plurality of Physical Resource Blocks (PRBs) within a first slot, wherein the HARQ feedbacks on the plurality of PSFCHs correspond to the plurality of physical sidelink channels.

34. The method as claimed in claim 33, wherein receiving the HARQ feedbacks on the plurality of PSFCHs comprises:
receiving a first HARQ feedback on a first PSFCH of the plurality of PSFCHs in a first PRB of the plurality of PRBs, wherein the first HARQ feedback corresponds to a latest physical sidelink channel of the plurality of physical sidelink channels; and
receiving second HARQ feedbacks on a plurality of second PSFCHs of the plurality of PSFCHs in the plurality of PRBs, wherein each of the second HARQ feedbacks corresponds to the latest physical sidelink channel or a previous physical sidelink channel of the plurality of physical sidelink channels.

35. The method as claimed in claim 33, wherein receiving the HARQ feedbacks on the plurality of PSFCHs comprises:
receiving a first HARQ feedback on a first PSFCH of the plurality of PSFCHs in a first PRB of the plurality of PRBs, wherein the first HARQ feedback corresponds to a physical sidelink channel of the plurality of physical sidelink channels transmitted to the first device in a latest slot;
receiving second HARQ feedbacks on a plurality of second PSFCHs of the plurality of PSFCHs in the plurality of PRBs other than the first PRB, wherein each of the second HARQ feedbacks corresponds to a physical sidelink channel of the plurality of physical sidelink channels transmitted to the first device in a second slot prior to the latest slot; and
receiving a NACK on a PSFCH corresponding to a second slot in which no PSCCH towards the first device is decoded at the first device.

36. The method as claimed in claim 33, wherein each of the plurality of physical sidelink channels includes a PSSCH index, and the method further comprises:
determining, based on the PSSCH index indicated implicitly or explicitly in the HARQ feedbacks, a HARQ feedback corresponding to one of the plurality of physical sidelink channels being missed; and
transmitting a HARQ retransmission of the one of the plurality of physical sidelink channels.

37. The method as claimed in claim 33, wherein receiving the HARQ feedbacks on the plurality of PSFCHs comprises:
receiving the HARQ feedbacks on the plurality of PSFCHs repeatedly transmitted at the plurality of PRBs.

38. The method as claimed in claim 33, wherein the method further comprises:
transmitting a maximum time threshold in the plurality of physical sidelink channels to the first device; and
receiving, from the first device, a subset of the HARQ feedbacks on the plurality of PSFCHs correspond to a subset of the plurality of physical sidelink channels, and wherein the subset of the plurality of physical sidelink channels is transmitted within the time threshold before the first slot.

39. The method as claimed in claim 33, wherein transmitting the plurality of physical sidelink channels comprises:
transmitting the plurality of physical sidelink channels including information on a PSFCH format,
wherein the PSFCH format indicates one of:
an association between the plurality of PRBs and the plurality of physical sidelink channels, or
an association between the plurality of PRBs and slots in which the plurality of physical sidelink channels are transmitted by the second device.

40. The method as claimed in claim 39, wherein receiving the HARQ feedbacks on the plurality of PSFCHs comprises:
receiving the HARQ feedbacks on the plurality of PSFCHs in the plurality of PRBs transmitted by the first device based on the PSFCH format.

41. A first device, comprising:
at least one processor; and
at least one memory including computer program codes;
the at least one memory and the computer program codes are configured to, with the at least one processor, cause the first device at least to perform at least the method as claims in claim 24.

42. A second device, comprising:
at least one processor; and
at least one memory including computer program codes;
the at least one memory and the computer program codes are configured to, with the at least one processor, cause the second device at least to perform at least the method as claimed in claim 33.
